(19) United States
(12) Patent Application Publication
(10) Pub. No.: US 2023/0029261 A1
(43) Pub. Date: Jan. 26, 2023

(54) ENERGY RECOVERY DEVICE

(71) Applicant: MAN Truck & Bus SE, München (DE)

(72) Inventor: Alexander Schydlo, MÜNCHEN (DE)

(73) Assignee: MAN Truck & Bus SE, München (DE)

(21) Appl. No.: 17/787,926

(22) PCT Filed: Dec. 7, 2020
(86) PCT No.: PCT/EP2020/084813

§ 371 Date: Jun. 21, 2022

(30) Foreign Application Priority Data
Dec. 21, 2019 (DE) 10 2019 009 037.3

(51) Int. Cl. H01M 8/04007; H01M 8/04746; H01M 8/04701

(52) U.S. Cl. CPC H01M 8/04074; H01M 8/04059; H01M 8/04776; H01M 8/04723; H01M 8/04738; H01M 8/04768; H01M 2250/20

(57) ABSTRACT

The invention relates to an energy recovery device for a motor vehicle, having a drive (10) and a fluid circuit (12) for utilising waste heat from the drive (10). A working fluid circulates in the fluid circuit (12). The fluid circuit (12) has a first heat exchanger (16), which is thermally coupled to the drive (10) for transferring waste heat from the drive (10) to the working fluid, an expansion machine (18), and an expansion machine bypass (20), which bypasses the expansion machine (18) and in which a second heat exchanger (22) is arranged.

The present disclosure relates to an energy recovery device with a drive unit and a fluid circuit for utilizing waste heat of the drive unit.

In motor vehicles, in particular commercial vehicles, with a fuel-cell drive, a stream of waste heat is produced in the energy generating process of the fuel-cell drive. This stream of waste heat may be much greater than in conventional drives. Since in fuel-cell drives the enthalpy flow of the exhaust gas is almost negligible and the efficiency of the fuel cell is for example on average 50%, it can be ascertained that the stream of waste heat that is transferred in the cooling system almost corresponds to the electrical power generated.

U.S. Pat. No. 10,252,610 B2 discloses an electric vehicle with a fuel cell and a Rankine cycling process for energy recovery from waste heat of the fuel cell. The system has an expansion machine and an expansion machine bypass. The expansion machine bypass is flowed through when the vehicle is not running or does not have to generate any electricity.

DE 10 2007 061 032 A1 discloses a cooling circuit for an internal combustion engine. In addition to the cooling circuit, a working circuit for energy recovery is provided. The working circuit has an expansion machine and an expansion machine bypass. Straight after starting the internal combustion engine, when the working medium of the working circuit is still in the liquid state, the expansion machine bypass is flowed through.

The present disclosure is based on the object of providing an alternative and/or improved technique for energy recovery from waste heat of a drive unit, preferably a fuel-cell drive.

The object is achieved by the features of independent claim 1. Advantageous developments are specified in the dependent claims and the description.

According to one aspect, an energy recovery device, for example for a motor vehicle, is disclosed. The device has a drive (for example an electric drive), preferably a fuel-cell drive. The device has a fluid circuit for utilizing waste heat of the drive. A working fluid (for example cooling fluid) circulates in the fluid circuit. The fluid circuit has a first heat exchanger, which is thermally coupled to the drive for transferring waste heat from the drive (for example a fuel-cell stack of the drive) to the working fluid. The fluid circuit has an expansion machine (for example a turbine expander, a scroll expander or a piston expander), which is arranged downstream of the first heat exchanger (for example for driving an electric generator, etc.). The fluid circuit has an expansion machine bypass, which bypasses the expansion machine and in which a second heat exchanger (for example a liquid heat exchanger) is arranged.

The device advantageously offers the possibility of recovering waste heat of the drive, preferably a fuel cell of the drive, and to do so independently of whether considerable waste heat or little waste heat occurs. By means of the expansion machine, energy can be recovered for example if the waste heat of the drive is great enough that the working fluid in the first heat exchanger can evaporate. By means of the second heat exchanger, energy can be recovered for example if the waste heat of the drive is not sufficient to evaporate the working fluid in the first heat exchanger, for example in the case of part load or when starting the drive. The device therefore also makes it possible to protect the expansion machine from (too much) liquid working fluid, energy recovery by means of the second heat exchanger still being possible even from the liquid, heated working fluid. In this way, the overall efficiency can be additionally increased. Furthermore, the electrical effective power of a fuel cell that is possibly used can be increased by the effective cooling. The effective cooling of the drive by means of the first heat exchanger with and without phase transformation can also make it possible to reduce the necessary heat-transferring surface area of the cooler of the drive.

The fluid circuit may preferably also have a third heat exchanger (for example a cooler or a condenser, for example fan-cooled), which may for example be arranged downstream of the expansion machine bypass and the expansion machine.

It is preferred that the fluid circuit may have a pump, which may for example be arranged upstream of the first heat exchanger.

In an exemplary embodiment, the second heat exchanger is thermally coupled to a system for transferring heat from the working fluid to the system (for example directly or indirectly). Consequently, the energy recovered can be used by the system system-specifically.

In a development, the system has a heater, an air-conditioning unit, a unit for controlling the temperature of the battery, a heat pump, a heat reservoir and/or a waste-heat recovery device (for example for converting thermal energy into mechanical energy).

In a further exemplary embodiment, the fluid circuit can be operated in dependence on the waste heat of the drive in an energy recovery mode with a phase transformation (for example evaporation) of the working fluid in the first heat exchanger, the working fluid only being fed essentially to the expansion machine after the phase transformation.

In a further exemplary embodiment, the fluid circuit can be operated in dependence on the waste heat of the drive in an energy recovery mode with heating, without a phase transformation of the working fluid in the first heat exchanger, the working fluid only being fed essentially to the second heat exchanger in the expansion machine bypass after the heating without the phase transformation.

In a further exemplary embodiment, the fluid circuit can be operated in dependence on the waste heat of the drive in an energy recovery mode with a partial phase transformation of the working fluid in the first heat exchanger. For example, the working fluid may be fed partly (for example the fraction in vapor form) to the expansion machine and partly (for example the liquid fraction) to the second heat exchanger in the expansion machine bypass after the partial phase transformation. As an alternative, the working fluid may only be fed essentially to the expansion machine after the partial phase transformation (for example in the form of wet steam).

In an embodiment, the fluid circuit has a valve device, which is arranged for adapting a fluid flow of the working fluid through the expansion machine and/or the expansion machine bypass.

In a development, the valve device can be adjusted into a (for example first) position, in which the fluid flow is only passed essentially through the expansion machine bypass. As an alternative or in addition, the valve device can be adjusted into a (for example second) position, in which the fluid flow is only passed essentially through the expansion machine. As an alternative or in addition, the valve device can be adjusted into a (for example third) position, in which the fluid flow is passed (for example in part) through the expansion machine and (for example in part) through the expansion machine bypass.

In a further embodiment, the valve device can be adjusted in a stepless or step-by-step manner, for example between the first position, the second position and the third position.

In a variant of the embodiment, the device has a control unit, which is designed to adjust the valve device (for example into the first position, second position and/or third position).

The term “control unit” may preferably refer to an electronic system (for example having (a) microprocessor(s) and a data store) and/or a mechanical control system which, depending on the configuration, can take over open-loop control tasks and/or closed-loop control tasks. Even if the term “control” is used herein, it may consequently as it were expediently also include “closed-loop control” or “control with feedback”.

In a development, the control unit is designed to adjust the valve device in dependence (for example directly or indirectly) on a phase, a vapor content and/or an amount of vapor of the working fluid.

In a further variant of the embodiment, the control unit is designed to adjust the valve device from the first position into the second position or the third position if the vapor content and/or the amount of vapor of the working fluid overshoots a predetermined (for example first) limit value (for example a first vapor-content limit value and/or first amount-of-vapor limit value). As an alternative or in addition, the control unit is designed to adjust the valve device from the third position into the second position if a vapor content and/or an amount of vapor of the working fluid overshoots a predetermined (for example second) limit value (for example second vapor-content limit value and/or second amount-of-vapor limit value). As an alternative or in addition, the control unit is designed to adjust the valve device from the second position into the first position or the third position if the vapor content and/or the amount of vapor of the working fluid undershoots a predetermined (for example third) limit value (for example third vapor-content limit value and/or third amount-of-vapor limit value). As an alternative or in addition, the control unit is designed to adjust the valve device from the third position into the first position if a vapor content and/or an amount of vapor of the working fluid undershoots a predetermined (for example fourth) limit value (for example fourth vapor-content limit value and/or fourth amount-of-vapor limit value).

In an exemplary embodiment, the control unit is designed to ascertain a phase, a vapor content and/or an amount of vapor of the working fluid on the basis of a signal from a temperature sensor, which is for example arranged downstream of the first heat exchanger, a signal from a pressure sensor, which is for example arranged downstream of the first heat exchanger, and/or a pump speed of a pump, which is for example arranged upstream of the first heat exchanger.

In a further exemplary embodiment, the control unit is designed to adjust the valve device in dependence on a load of the drive. In the case of a part load of the drive, the valve device may preferably be adjusted to the first position or the third position. As an alternative or in addition, in the case of a full load of the drive, the valve device may be adjusted to the second position or the third position. This load-dependent control can be realizable relatively easily.

In an embodiment, the fluid circuit also has a throttle, which is preferably arranged in the expansion machine bypass and/or downstream of the second heat exchanger. As an alternative, the throttle may for example be arranged in a further expansion machine bypass, which bypasses the expansion machine (for example parallel to the expansion machine bypass). In this case, the valve device may for example be arranged in addition for adapting a fluid flow of the working fluid through the further expansion machine bypass. As an alternative or in addition, the fluid circuit has a further expansion machine bypass, which bypasses the expansion machine. For example, the further expansion machine bypass may be flowed through by working fluid if only a cooling of the drive is desired. The valve device can preferably be adjusted into a fourth position, in which the working fluid is only passed essentially through the further expansion machine bypass.

In a further embodiment, the fluid circuit also has a liquid-vapor separator (for example a condensate drain), which is preferably arranged at a branch point of the expansion machine bypass and/or upstream of the expansion machine. For example, the liquid-vapor separator may direct a liquid fraction of the working fluid to the expansion machine bypass. For example, the liquid-vapor separator may direct a fraction in vapor form of the working fluid (for example wet steam or superheated steam) to the expansion machine.

It is also possible that the expansion machine bypass and/or the further expansion machine bypass serves as overload protection for the expansion machine. For example, the control unit may adjust the valve device into the first position or the fourth position if a temperature and/or a pressure (for example detected by at least one sensor) downstream of the first heat exchanger overshoots a predetermined, corresponding (for example temperature and/or pressure) limit value.

According to a further aspect, the present disclosure relates to a motor vehicle, preferably a commercial vehicle (for example a truck or an omnibus), with a device as disclosed herein.

It is also possible to use the device as disclosed herein for passenger cars, large engines, off-road vehicles, stationary installations, on ships, etc.

The preferred embodiments and features of the present disclosure described above can be combined with one another as desired. Further details and advantages of the present disclosure are described below with reference to the appended drawing, in which:

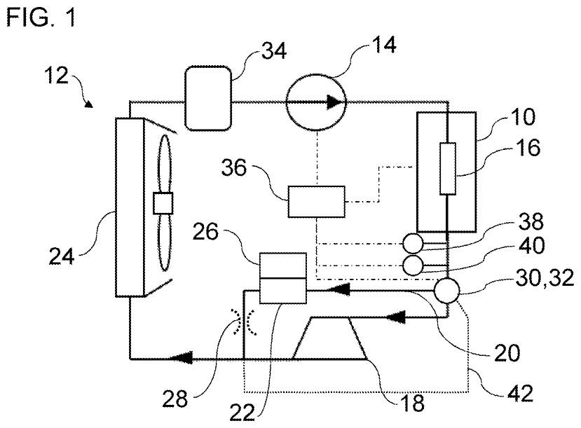

FIG. 1 shows a schematic view of a fluid circuit for energy recovery from waste heat of a drive.

FIG. 1 shows a drive 10 and a fluid circuit 12 for utilizing waste heat of the drive 10. A working fluid (for example an organic liquid with a low evaporation temperature) circulates in the fluid circuit 12.

It is particularly preferred that the drive 10 is embodied as a fuel-cell drive for driving a motor vehicle, preferably a commercial vehicle. In particular in such an embodiment, the advantages of the fluid circuit disclosed herein for utilizing waste heat can be used particularly advantageously. If the fuel cells are for example operated under full load, the thermal capacity of the fluid circuit 12 for cooling the fuel cells can be increased by a phase transformation of a working fluid of the fluid circuit 12 taking place. It is however also possible to apply the techniques disclosed herein for example to a conventional drive or other electrical drive or in combination therewith (for example a hybrid vehicle).

The fluid circuit 12 has a pump 14, a first heat exchanger 16, an expansion machine 18, an expansion machine bypass 20, a second heat exchanger 22 and a third heat exchanger 24.

The first heat exchanger 16 is arranged downstream of the pump 14. The expansion machine 18 is arranged downstream of the first heat exchanger 16. The expansion machine bypass 20 bypasses the expansion machine 18. The expansion machine bypass 20 connects a branching point upstream of the expansion machine 18 to a connecting point downstream of the expansion machine 18. The second heat exchanger 22 is arranged in the expansion machine bypass 20. The third heat exchanger 24 is arranged downstream of the expansion machine 18 and the expansion machine bypass 20.

The pump 14 transports the working fluid circulating in the fluid circuit 12. The working fluid may be or comprise for example water, a water-glycol mixture, an organic fluid, an inorganic fluid or an alcohol.

The first heat exchanger 16 is thermally coupled to the drive 10 for transferring the waste heat of the drive 10 to the working fluid of the fluid circuit 12. For example, the first heat exchanger 16 may be integrated directly in the drive 10, preferably in a fuel-cell stack of the drive 10, for direct cooling thereof. It is however also possible for example that the first heat exchanger 16 is flowed through not only by the working fluid but also by a cooling fluid of a cooling circuit of the drive 10, preferably the fuel-cell stack of the drive 10, in order to cool the cooling fluid.

In the expansion machine 18, the internal energy of the evaporated working fluid is reduced by expanding of the working fluid and is thereby partially converted into mechanical energy. As a result, for example, an output element, such as an output shaft, of the expansion machine 18 may be driven. The expansion machine 18 may be embodied for example as a turbine (as represented in FIG. 1), a piston machine or a scroll expander.

The output element of the expansion machine 18 may for example also be connected in driving terms to a generator, in order to obtain electrical energy from the mechanical energy recovered. The electrical energy may for example be buffer-stored in a battery (for example), fed into an electrical system on board the motor vehicle, fed to an electric motor for driving the motor vehicle or fed to a secondary consumer (for example the cooler fan of the third heat exchanger 24, the pump 14, an e-booster, etc.).

The second heat exchanger 22 is thermally coupled to a system 26 for transferring heat from the working fluid to the system 26. The second heat exchanger 22 is embodied to receive the working fluid in a liquid phase.

The system 26 may have a heater (for example a vehicle heater), an air-conditioning unit (for example a vehicle air-conditioning unit), a unit for controlling the temperature of the battery (for example a system for controlling the temperature of the traction battery), a heat pump, a heat reservoir and/or a waste-heat recovery device (for example for converting thermal energy into mechanical energy).

It is possible that the system 26 is at least partially activatable and deactivatable. When the system 26 is deactivated, the liquid working fluid that flows through the second heat exchanger 22 is essentially not cooled down when it flows through the heat exchanger 22. In particular, in such an embodiment, a throttle 28 may be arranged downstream of the heat exchanger 22 in the expansion machine bypass 20. In the throttle 28, the liquid working fluid may be throttled before it reaches the third heat exchanger 24, while destroying exergy.

For adapting a fluid flow through the expansion machine bypass 20 and the expansion machine 18, a valve device 30 may be provided. The valve device 30 may have one or more valves. The valve device 30 may be arranged in the expansion machine bypass 20, at the branching of the expansion machine bypass 20 from the fluid line upstream of the expansion machine 18 and/or in the fluid line upstream of the expansion machine 18.

It is also possible that for example a liquid-vapor separator 32 is provided in addition or as an alternative to the valve device 30. The liquid-vapor separator 32 may be arranged at the branching point of the expansion machine bypass 20 upstream of the expansion machine 18. For example, the liquid-vapor separator 32 may be integrated with the valve device 30. The liquid-vapor separator 32 may divide the incoming working fluid into a liquid part and a part in vapor form. The liquid part of the working fluid may be directed to the expansion machine bypass 20. The part in vapor form of the working fluid may be directed to the expansion machine 18.

In the third heat exchanger 24, the working fluid is cooled down. The third heat exchanger 24 may be cooled by means of a preferably electrically driven fan. In the exemplary embodiment of FIG. 1, the third heat exchanger 24 may also be operated as a condenser. The condenser condenses the working fluid—if required—completely, so that the pump 14 can take in the liquid working fluid again. It is additionally possible that the fluid circuit 12 has a liquid separator 34 upstream of the pump 14.

The fluid circuit 12 can be operated in different modes in dependence on the waste heat of the drive 10.

In a first energy recovery mode, the working fluid is heated by the waste heat of the drive 10 in the first heat exchanger 16. The waste heat is not sufficient to evaporate the working fluid. The working fluid leaves the first heat exchanger 16 in a liquid state. After being heated in the first heat exchanger 16, the working fluid only flows through the expansion machine bypass 20 and the second heat exchanger 22. The expansion machine 18 is not flowed through. Waste heat of the drive 10 can consequently be further utilized indirectly by means of the second heat exchanger 22 in the system 26.

It is possible that the liquid circuit 12 can be operated in a second energy recovery mode. In the second energy recovery mode, the working fluid is heated by the waste heat of the drive 10 in the first heat exchanger 16. The waste heat is sufficient to evaporate the working fluid. The working fluid leaves the first heat exchanger 16 in the form of vapor. After being heated in the first heat exchanger 16, the working fluid only flows through the expansion machine 18. The expansion machine bypass 20 and the second heat exchanger 22 are not flowed through. Waste heat of the drive 10 can consequently be further utilized indirectly by means of the expansion machine 18, for example for driving a generator, etc. In the second energy recovery mode, a Clausius-Rankine cycling process, in particular a so-called Organic Rankine cycling process, may be realized.

It is also possible that the fluid circuit 12 can be operated in a third energy recovery mode. In the third energy recovery mode, the working fluid is heated by the waste heat of the drive 10 in the first heat exchanger 16. The waste heat is only sufficient to partially evaporate the working fluid. The working fluid leaves the first heat exchanger partly in the form of vapor. After being heated in the first heat exchanger 16, a liquid part of the working fluid flows through the expansion machine bypass 20 and the second heat exchanger 22. After being heated in the first heat exchanger 16, a part in vapor form of the working fluid flows through the expansion machine 18. Waste heat of the drive 10 can consequently be further utilized indirectly by means of the second heat exchanger 22 and by means of the expansion machine 18.

It is also possible that the fluid circuit 12 can be operated in a pure cooling mode. In the cooling mode, the working fluid is heated by the waste heat of the drive 10 in the first heat exchanger 16. The waste heat is not sufficient to evaporate the working fluid. The working fluid leaves the first heat exchanger 16 in a liquid state. After being heated in the first heat exchanger 16, the working fluid only flows through the expansion machine bypass 20 and the second heat exchanger 22. The system 26 is deactivated. Essentially no heat is transferred to the system 26 by means of the second heat exchanger 22. The working fluid can be throttled in the throttle 28, if present. The working fluid is cooled in the third heat exchanger 24.

The distribution of the working fluid between the expansion machine bypass 20 and the expansion machine 18 for realizing the desired mode can take place automatically or in a forcibly controlled manner by the liquid-vapor separator 32, if present.

As an alternative or in addition, the distribution of the working fluid between the expansion machine bypass 20 and the expansion machine 18 for realizing the desired mode may take place by means of adjusting the valve device 30, if present.

The valve device 30 may for example be adjusted into a first position, a second position and/or a third position.

In the first position, the working fluid is only directed to the expansion machine bypass 20. The expansion machine 18 is not flowed through. In this way for example the first energy recovery mode and the cooling mode can be realized.

In the second position, the working fluid is only directed to the expansion machine 18. The expansion machine bypass 20 is not flowed through. In this way for example the second energy recovery mode can be realized.

In the third position, the working fluid is directed with a liquid fraction to the expansion machine bypass 20 and with a fraction in vapor form to the expansion machine 18. In this way for example the third energy recovery mode can be realized.

For adjusting the valve device 30 (or for activating an actuator for adjusting the valve device 30), a control unit 36 may be provided.

The control unit 36 may adjust the valve device 30 for example on the basis of a pump speed of the pump 14, a temperature signal of a temperature sensor 38 and/or a pressure signal of a pressure sensor 40. The temperature sensor 38 and the pressure sensor 40 may be arranged downstream of the first heat exchanger 16 and upstream of the expansion machine 18 and/or the second heat exchanger 22. On the basis of the signals, the control unit 36 may ascertain a phase, a vapor content and an amount of vapor of the working fluid downstream of the first heat exchanger 16. On the basis of this, the valve device 30 can be adjusted into the respectively associated position. One or more limit values for the vapor content and/or the amount of vapor may be specified, and an associated adjustment of the valve device 30 is triggered when they are undershot or overshot.

As an alternative or in addition, the control unit 36 may adjust the valve device 30 for example in dependence on a load of the drive 10. In the case of a part load of the drive 10, the valve device may be adjusted to the first position (for example in the case of weak load) or the third position (for example moderate load). In the case of a full load of the drive 10, the valve device 30 may be adjusted to the second or third position.

It is also possible for example that an optional further expansion machine bypass 42, which bypasses the expansion machine 18 (and the expansion machine bypass 20), is arranged for the cooling mode and/or for starting the drive 10 and/or for overload protection of the expansion machine 18. The valve device 30 may likewise adapt a feed of the working fluid to the further expansion machine bypass 42. It is possible that the throttle 28 may be arranged in the expansion machine bypass 42, for example also as a portion of the valve device 30.

An arrangement with two expansion machine bypasses 20, 42 can also significantly increase a variability of the fluid circuit 12. If, for example, no energy recovery by means of the expansion machine 18 and by means of the second heat exchanger 22 is desired, only the further expansion machine bypass 42 may be flowed through. It is also possible that only a fraction of the working fluid flows through the further expansion machine bypass 42 and the remainder flows through the expansion machine 18 and/or the expansion machine bypass 20.

The scope of the present disclosure is not limited to the preferred exemplary embodiments described above. Rather, a variety of variants and modifications which also make use of the inventive concept and therefore fall within the scope of protection are possible. In particular, the present disclosure also claims protection for the subject matter and the features of the dependent claims, regardless of the referenced claims. In particular, the individual features of independent claim 1 are disclosed in each case independently of one another. In addition, the features of the dependent claims are also disclosed independently of all of the features of independent claim 1 and for example disclosed independently of the features with respect to the presence and/or the configuration of the drive and/or the fluid circuit of independent claim 1.

### LIST OF REFERENCE SIGNS

10 Drive
12 Fluid circuit
14 Pump
16 First heat exchanger
18 Expansion machine
20 Expansion machine bypass
22 Second heat exchanger
24 Third heat exchanger
26 System
28 Throttle
30 Valve device
32 Liquid-vapor separator
34 Liquid separator
36 Control unit
38 Temperature sensor
40 Pressure sensor
42 Further expansion machine bypass

1-15. (canceled)

16. An energy recovery device for a motor vehicle, having:
a drive; and
a fluid circuit for utilizing waste heat of the drive, a working fluid circulating in the fluid circuit and the fluid circuit having:
a first heat exchanger, which is thermally coupled to the drive for transferring waste heat from the drive to the working fluid;
an expansion machine, which is arranged downstream of the first heat exchanger; and
an expansion machine bypass, which bypasses the expansion machine and in which a second heat exchanger is arranged.

17. The device as claimed in claim 16, wherein the drive is a fuel-cell drive.

18. The device as claimed in claim 16, wherein:
the second heat exchanger is thermally coupled to a system for transferring heat from the working fluid to the system.

19. The device as claimed in claim 18, wherein:
the system has a heater, an air-conditioning unit, a unit for controlling the temperature of the battery, a heat pump, a heat reservoir and/or a waste-heat recovery device.

20. The device as claimed in claim 16, wherein the fluid circuit can be operated in dependence on the waste heat of the drive:
in an energy recovery mode with a phase transformation of the working fluid in the first heat exchanger, the working fluid only being fed essentially to the expansion machine after the phase transformation; and/or
in an energy recovery mode with heating, without a phase transformation of the working fluid in the first heat exchanger, the working fluid only being fed essentially to the second heat exchanger in the expansion machine bypass after the heating without the phase transformation.

21. The device as claimed in claim 16, wherein the fluid circuit can be operated in dependence on the waste heat of the drive: in an energy recovery mode with a partial phase transformation of the working fluid in the first heat exchanger, the working fluid being fed partly to the expansion machine and partly to the second heat exchanger in the expansion machine bypass after the partial phase transformation; or the working fluid only being fed essentially to the expansion machine after the partial phase transformation.

22. The device as claimed in claim 16, wherein:
the fluid circuit has a valve device, which is arranged for adapting a fluid flow of the working fluid through the expansion machine and the expansion machine bypass,
wherein:
the valve device can be adjusted into a first position, in which the fluid flow is only passed essentially through the expansion machine bypass; and/or
the valve device can be adjusted into a second position, in which the fluid flow is only passed essentially through the expansion machine; and/or
the valve device can be adjusted into a third position, in which the fluid flow is passed through the expansion machine and the expansion machine bypass.

23. The device as claimed in claim 22, wherein:
the valve device can be adjusted in a stepless or step-by-step manner.

24. The device as claimed in claim 22, further comprising:
a control unit, which is designed to adjust the valve device.

25. The device as claimed in claim 24, wherein:
the control unit is designed to adjust the valve device in dependence on a phase, a vapor content and/or an amount of vapor of the working fluid.

26. The device as claimed in claim 25, wherein:
the control unit is designed to adjust the valve device from the first position into the second position or the third position if the vapor content and/or the amount of vapor of the working fluid overshoots a predetermined limit value; and/or
the control unit is designed to adjust the valve device from the third position into the second position if a vapor content and/or an amount of vapor of the working fluid overshoots a predetermined limit value; and/or
the control unit is designed to adjust the valve device from the second position into the first position or the third position if the vapor content and/or the amount of vapor of the working fluid undershoots a predetermined limit value; and/or
the control unit is designed to adjust the valve device from the third position into the first position if a vapor content and/or an amount of vapor of the working fluid undershoots a predetermined limit value.

27. The device as claimed in claim 24, wherein:
the control unit is designed to ascertain a phase, a vapor content and/or an amount of vapor of the working fluid on the basis of a signal from a temperature sensor, which is arranged downstream of the first heat exchanger, a signal from a pressure sensor, which is arranged downstream of the first heat exchanger, and/or a pump speed of a pump, which is arranged upstream of the first heat exchanger.

28. The device as claimed in claim 24, wherein:
the control unit is designed to adjust the valve device in dependence on a load of the drive.

29. The device as claimed in claim 28, wherein:
the valve device is adjusted to the first position or the third position in the case of a part load of the drive; and/or
the valve device is adjusted to the second position or the third position in the case of a full load of the drive.

30. The device as claimed in claim 16, wherein:
the fluid circuit also has a throttle, which is arranged in the expansion machine bypass downstream of the second heat exchanger or in a further expansion machine bypass, which bypasses the expansion machine; and/or
the fluid circuit also has a further expansion machine bypass, which bypasses the expansion machine.

31. The device as claimed in claim 16, wherein:
the fluid circuit also has a liquid-vapor separator, which is arranged at a branching point of the expansion machine bypass upstream of the expansion machine.

32. A motor vehicle comprising a device as claimed in claim 16.

33. The motor vehicle of claim 32, wherein the motor vehicle is a commercial vehicle.
